(19) United States
(12) Patent Application Publication
(10) Pub. No.: US 2024/0411152 A1
(43) Pub. Date: Dec. 12, 2024

(54) EYEGLASSES WITH MAGNETIC INTERCHANGEABLE ARMS

(71) Applicant: cFrames Holdings LLC, Medford, MA (US)

(72) Inventor: Evan Michael Wildenhain, Warwick, RI (US)

(73) Assignee: cFrames Holdings LLC, Medford, MA (US)

(21) Appl. No.: 18/331,641

(22) Filed: Jun. 8, 2023

(51) Int. Cl. G02C 5/14

(52) U.S. Cl. CPC G02C 5/146; G02C 2200/02; G02C 2200/08

(57) ABSTRACT

Eyeglasses with interchangeable arms are disclosed. The eyeglasses may include a frame, a first connector and an arm. The first connector may be attached with a frame side portion and may include a first magnetic element and a second magnetic element. The arm may include a second connector having a third magnetic element and a fourth magnetic element. The arm may removably attach with the frame by using magnetic coupling between the first and third magnetic elements, and the magnetic coupling between the second and fourth magnetic elements. The first, second, third and fourth magnetic elements may be magnets or ferrous materials. The first connector may include a protrusion or a cavity, and the second connector may include a complementary cavity or protrusion of similar shape and dimension.

### TECHNICAL FIELD

The present disclosure relates to eyeglasses, and more specifically to customizable eyeglasses having interchangeable arms and fascia.

### BACKGROUND

Users with impaired vision generally wear prescription eyeglasses to improve their eyesight. The users may also wear sunglasses to protect their eyes from sunlight and harmful radiations. In addition, many users may treat eyeglasses as part of their fashion accessory.

Irrespective of whether the eyeglasses are used to improve eyesight or worn as sunglasses, the eyeglasses alter wearer's appearance. Therefore, users spend considerable effort in selecting appropriate design and color of eyeglasses that match their personality and complement their appearance.

Conventional eyeglasses have frames that may be pivotally connected with a pair of temples or arms. The arms are generally connected with the frames using screws and hinges. The conventional eyeglasses may not be easily customizable due to connections between the frames and the arms. For example, if a user desires to change color or design of the arms, the user may have to unscrew existing arms, replace them with new arms of different design or color, and then screw the new arms again to the frame. This process of unscrewing and screwing of arms may be inconvenient to users. In addition, the users may need professional help and/or specialized equipment to screw/unscrew delicate arms from eyeglasses frames.

Further, the conventional eyeglasses may not enable users to change design and/or color of eyeglasses front face. For example, if the user desires to change color of eyeglasses front face to match with a color of a dress that the user may be wearing, the user may have to purchase new eyeglasses, as the conventional eyeglasses may not enable easy customization of eyeglasses front face.

Furthermore, if the user inadvertently damages one or both arms, or the front face, the user may have to purchase new eyeglasses, as the conventional eyeglasses may not enable replacement of damaged component easily. It may be inconvenient for users to frequently purchase new eyeglasses, especially prescription eyeglasses, which may be expensive.

Thus, there is a need for customizable eyeglasses that may enable users to conveniently change eyeglasses appearance, without requiring professional help and/or specialized equipment or tools.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts example eyeglasses in accordance with the present disclosure.

FIG. 2 depicts example eyeglasses with removable arms in accordance with the present disclosure.

FIG. 3 depicts example embodiments of an arm and a connector of eyeglasses in accordance with the present disclosure.

FIG. 4 depicts example eyeglasses with removable arms in accordance with the present disclosure.

FIG. 5A depicts example eyeglasses with removable fascia in accordance with the present disclosure.

FIG. 5B depicts another embodiment of the eyeglasses of FIG. 5A with the removable fascia in accordance with the present disclosure.

FIG. 6 depicts an example connection mechanism between a frame and a fascia of eyeglasses of FIG. 5A in accordance with the present disclosure.

FIG. 7 depicts another example connection mechanism between a fascia and a frame of eyeglasses in accordance with the present disclosure.

FIG. 8 depicts a flow diagram of an example method to customize eyeglasses in accordance with the present disclosure.

### DETAILED DESCRIPTION

### Overview

The present disclosure is directed towards customizable eyeglasses configured to removably attach with interchangeable arms. The eyeglasses may include a frame, a first connector and an arm. The frame may include a frame front portion, a frame back portion opposite to the frame front portion, and a frame side portion. The frame may further include a clip or a recess that may be disposed along an interior frame surface. A user may removably attach lens to the frame via the clip. Specifically, the clip may enclose lens side surfaces. The first connector may have an elongated shape, and may disposed at the frame side portion. The first connector may include one or more magnetic elements disposed at a first connector proximal portion and/or a first connector distal portion. In some aspects, the first connector may include a metal (e.g., a ferrous metal) and may not include magnets. The arm may include a second connector that may have a shape complementary to front connector elongated shape. The second connector may also include one or more magnetic elements that may be disposed at a second connector proximal portion and/or a second connector distal portion. In some aspects, the second connector may be shaped as a cuboid and two side surfaces (e.g., left and right side surfaces) of the second connector may include magnetic strips. In other aspects, all four surfaces (top, bottom, left and right surfaces) of the second connector may include magnetic strips. A user may removably attach the arm with the first connector by using magnetic coupling of magnetic elements associated with the first connector and the second connector, or the magnetic coupling of the second connector with the metal of the first connector.

In an exemplary aspect, the first connector may include a protrusion and the second connector may include a cavity having complementary shape as the protrusion. The user may insert the first connector (via the protrusion) into the cavity to attach the arm with the first connector. In a similar manner, the user may “pull” the arm from the first connector to remove the arm from the first connector.

The present disclosure is further directed towards customizable eyeglasses configured to removably attach with an interchangeable fascia. The fascia may include a fascia front side and a fascia back side opposite to the fascia front side. The fascia back side may include one or more magnetic fasteners or one or more strips of magnetic elements that may be disposed at the fascia back side. In other aspects, the fascia back side may include a metallic strip or metallic elements (e.g., ferrous material). The frame may include complementary magnetic elements or strips of magnetic elements disposed at the frame front side. The user may removably attach the fascia to the frame by using magnetic coupling of respective magnetic elements/strips of the fascia back side and the frame front side, or magnetic coupling of frame magnetic elements/strips and the metal disposed at the fascia back side.

The fascia may further include a mechanical locking mechanism (e.g., a first mechanical locking mechanism) that may be disposed at a fascia top portion. The mechanical locking mechanism may be in a form of a “clip” that may be disposed on an entire fascia top portion length or a portion of fascia top portion length (e.g., at a fascia top middle portion). The user may lock the fascia top portion over a frame top portion by using the mechanical locking mechanism. The mechanical locking mechanism may supplement magnetic coupling of respective magnetic elements/strips and metal of the fascia back side and the frame front side, thus enabling secure frame and fascia attachment. In the aspect where the mechanical locking mechanism is disposed at the fascia top middle portion, the frame may include a corresponding “socket” or cavity into which the mechanical locking mechanism may be locked or hooked.

In additional aspects, the fascia may include another (e.g., a second) mechanical locking mechanism that may be disposed at a fascia bottom portion. The second mechanical locking mechanism may be similar to the first mechanical locking mechanism, and may enable secure frame and fascia attachment.

The present disclosure discloses customizable eyeglasses that may enable the user to easily change eyeglasses appearance by changing eyeglasses arms and/or fascia. Since the coupling between eyeglasses frame and the arm/fascia is via magnetic means, the user may conveniently interchange arms and/or fascia without requiring any professional help or specialized equipment. Further, additional presence of mechanical locking mechanism on the fascia may enable secure and robust frame and fascia attachment.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

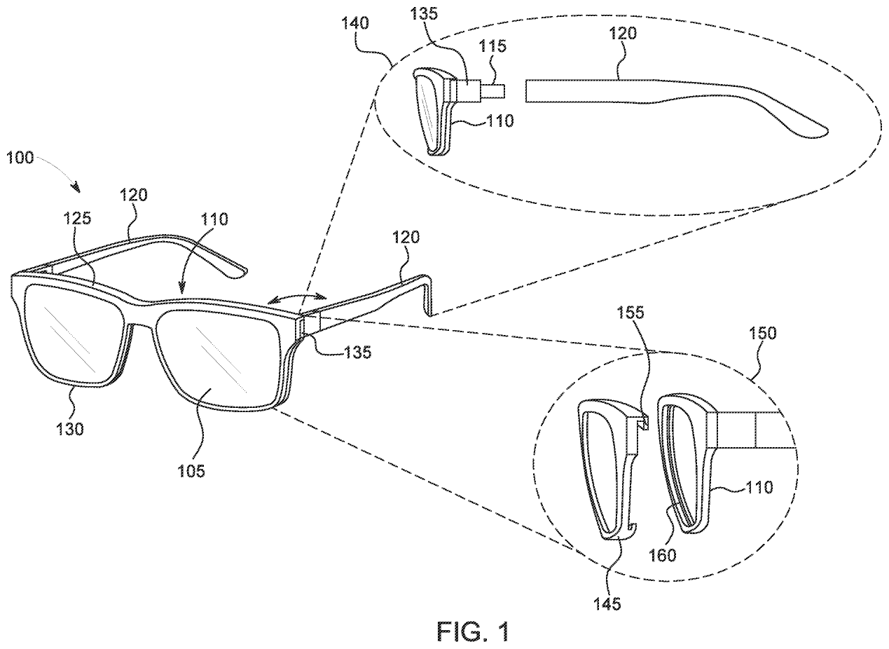

FIG. 1 depicts example eyeglasses 100 in accordance with the present disclosure. The eyeglasses 100 may be prescription eyeglasses or sunglasses. In an aspect where the eyeglasses 100 may be prescription eyeglasses, a user (not shown) may wear the eyeglasses 100 to improve user's vision or eyesight. In this case, lens 105 may have a predefined power (measured in diopters) that may assist the user with impaired vision to improve eyesight. In an aspect where the eyeglasses 100 may be sunglasses, the user may wear the eyeglasses 100 to protect user's eyes from sunlight or harmful radiations. In this case, the lens 105 may have dark color and include a layer of protective material (e.g., Ultraviolet coating) that may prevent harmful solar radiations from entering user's eyes.

The eyeglasses 100 may include a frame 110 and a pair of arms 120 (or an arm 120). The arms 120 may be connected with the frame 110 via a pair of connectors 115 (or a connector 115). The frame 110, the connector 115 and the arm 120 may be made of same or different material and may have same or different color/design. For example, the frame 110 and the arm 120 may be made of plastic, synthetic resin, metal, polymeric material, or a combination thereof. The connector 115 may be made of metal and/or magnetic material. In a preferred embodiment, the connector 115 may be made of metal. In additional aspects, the frame 110, the connector 115 and/or the arm 120 may include one or more layers of different materials attached together. For example, the frame 110 may include an interior surface (or an “interior frame”, not shown) that may be made of metal, and an exterior surface that may be made of plastic. Similarly, the connector 115 and/or the arm 120 may include interior and exterior surfaces made of different materials.

The frame 110 may include a frame top portion 125, a frame bottom portion 130 and a frame side portion 135. The connector 115 may be attached with the frame side portion 135 via a fastening mechanism (such as a screw and/or an adhesive, not shown). The connector 115 may be configured to rotate relative to a frame longitudinal axis via the frame side portion 135 (which may be hinged).

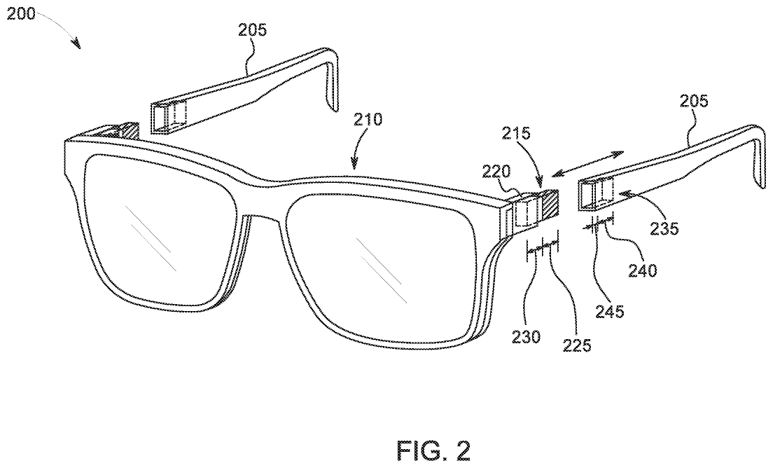

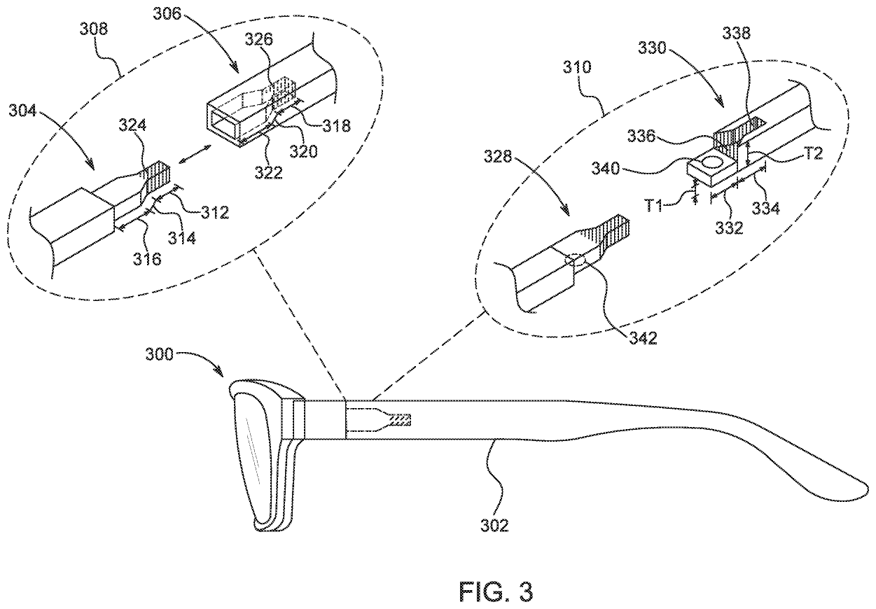

In some aspects, the connector 115 may be configured to removably attach with the arm 120, as shown in view 140. Stated another way, the arm 120 may be interchangeably attached to the frame 110 (e.g., to the frame side portion 135) via the connector 115. In some aspects, the arm 120 and the connector 115 may be removably attached with each other via a first magnetic coupling means (shown in FIG. 2 and FIG. 3), as described later in detail in the description below.

Interchangeable arm 120 may enable the user to conveniently change eyeglasses appearance (specifically, side appearance). For example, the user may change arms of different colors based on colors of dresses worn by the user. Further, since the arm 120 and the connector 115 may be magnetically coupled with each other, the user may easily assemble and disassemble the arm 120 and the connector 115, without requiring any professional help or specialized equipment.

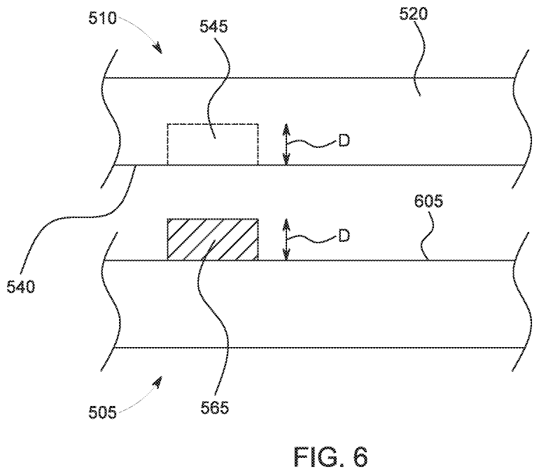

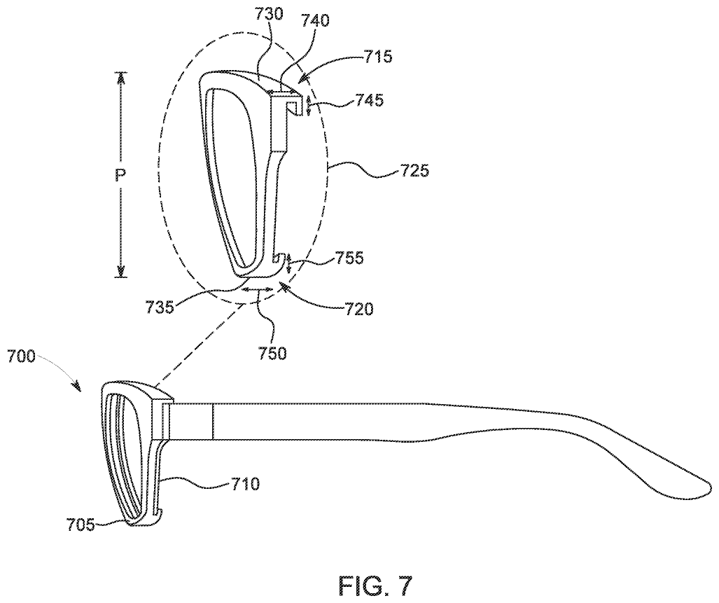

In further aspects, the eyeglasses 100 may enable the user to attach an external fascia 145 to the eyeglasses 100, as shown in view 150. The fascia 145 may removably attach to the frame 110 via a second magnetic coupling means (shown in FIG. 6) and/or mechanical attachment means (shown in FIG. 7). Specifically, as shown in the view 150, fascia top and bottom portions may include clips 155 (i.e., the mechanical attachment means)) that may enable the user to removably attach the fascia 145 to frame top and bottom portions respectively.

The fascia 145 may have same or equivalent dimensions as the frame 110, and thus the user may conveniently attach/remove the fascia 145 to/from the frame 110. Further, as shown in the view 150, the frame 110 may include a recess 160 that may be used by the user to removably attach the lens 105 into the frame 110. The recess 160 may be disposed along a frame interior surface.

Similar to interchangeable arms 120, interchangeable fascia 145 may enable the user to change eyeglasses appearance (specifically, front appearance). For example, the user may change fascia 145 (e.g., of different color and/or design) based on the dress worn by the user. The user may also mix and match colors of the interchangeable arms 120 and the fascia 145 to complement user's personality and/or preferences (e.g., for a particular occasion, such as a party). In addition, the user may change only the arms 120 (and not fascia 145), or change only the fascia 145 (and not the arms 120). In some aspects, the user may change both the arms 120 and the fascia 145.

FIG. 2 depicts example eyeglasses 200 with removable arms 205 in accordance with the present disclosure. The eyeglasses 200 may be same as or similar to the eyeglasses 100, and the arms 205 may be same as or similar to the arms 120.

The eyeglasses 200 may include a frame 210 and a first connector 215. The frame 210 may be same as or similar to the frame 110, and the first connector 215 may be similar to the connector 115. The frame 210 may include a frame side portion 220, and the first connector 215 may be attached to the frame side portion 220 via a fastening mechanism (such as a screw or an adhesive, not shown). In some aspects, the first connector 215 may be an elongated protrusion integrated with the frame side portion 220. Stated another way, the first connector 215 may be an integral part of the frame side portion 220. In other aspects (as shown in FIG. 2), the first connector 215 may be “inserted” into the frame side portion 220 (and adhesively attached) such that some part of the first connector 215 may be inside the frame side portion 220, and some part of the first connector 215 may be outside the frame side portion 220, as described in detail below.

In some aspects, the first connector 215 may have a length in a range of 5-20% of an arm 205 length. Further, the first connector 215 may be shaped as a cuboid, and may include an elongated first connector proximal portion 225 and a first connector distal portion 230. The cuboid-shaped first connector 215 may have a width of each side in a range of 0.25-0.75 centimeter. In some aspects, first connector 215 length and width of each side may be based on eyeglasses 200 design and dimensions.

A predetermined part (e.g., a distal part) of the first connector distal portion 230 may be disposed inside the frame side portion 220 (and adhesively attached), as shown in FIG. 2. Specifically, a distal part/end of the first connector distal portion 230 may be disposed/inserted inside the frame side portion 220. The distal part may be attached to the frame side portion 220 via the fastening mechanism described above. In some aspects, a length of the distal part of the first connector distal portion 230 may be in a range of 5-35% of first connector 215 length. Further, a proximal part of the first connector distal portion 230 may be disposed outside the frame side portion 220. In an exemplary aspect, the proximal part of the first connector distal portion 230 may have a length in a range of 65-95% of first connector 215 length.

In some aspects, the first connector proximal portion 225 and the first connector distal portion 230 may form an integrated structure (i.e., an integrated first connector 215 structure).

The first connector proximal portion 225 may be configured to removably attach with the removable arms 205. In some aspects, the first connector proximal portion 225 may include a first magnetic element, which may be a magnet or a ferrous material (e.g., iron, type 430, 434 or other 400 series stainless steel, etc.). In a preferred aspect, the first connector proximal portion 225 is a metal. In some aspects, an entire first connector proximal portion 225 length may include the first magnetic element or the metal. In other aspects, a portion (e.g., 50% or 60%) of first connector proximal portion 225 length may include the first magnetic element or the metal. The first connector 215 may removably attach with the arm 205 via the first magnetic element or the metal.

In some aspects, the arm 205 may include a second connector 235 that may be a cavity disposed inside an arm distal portion. The second connector 235 may be shaped (e.g., have length, width, etc.) similar to the first connector 215, such that the user may removably attach the first connector 215 with the second connector 235 (e.g., easily “insert” the first connector 215 into the second connector 235). Specifically, the cavity (or the second connector 235) may be complementary in shape to the first connector proximal portion 225 and the proximal part of the first connector distal portion 230, such that the cavity may engulf/enclose the first connector proximal portion 225 and the proximal part of the first connector distal portion 230 when the user inserts the first connector 215 into the second connector 235.

The second connector 235 may include a second connector proximal portion 240 (or a cavity proximal portion) and a second connector distal portion 245 (or a cavity distal portion). The second connector proximal portion 240 may have same length/shape as a first connector proximal portion 225 length/shape, and the second connector distal portion 245 may have same length/shape as the length/shape of the proximal part of the first connector distal portion 230.

In some aspects, the second connector proximal portion 240 (specifically, an interior surface of cavity) may include a second magnetic element, which may complement with the first magnetic element or the metal of the first connector proximal portion 225. Stated another way, the second magnetic element may include a magnet or a ferrous material. In a preferred aspect, one or more side surfaces (top, bottom, left and/or right surfaces) of the second connector proximal portion 240 may include strips of first magnetic element (e.g., magnetic strips). The magnetic strips may have a thickness in a range of 0.2 to 1 millimeter. In a preferred aspect, the magnetic strips may have a thickness of 0.5 mm.

The user may removably attach the second connector 235 with the first connector 215 by using magnetic coupling between the first magnetic element or the metal and the second magnetic element. Specifically, when the user inserts the first connector 215 into the second connector 235 (i.e., into the cavity), the second magnetic element and the first magnetic element or the metal may attract towards each other, and may enable the first connector 215 to attach with the second connector 235.

In some aspects, an entire second connector proximal portion 240 length may include the second magnetic element or the magnetic strips. In other aspects, a portion (e.g., 50% or 60%) of second connector proximal portion 240 length may include the second magnetic element or the magnetic strips. In a preferred aspect, a magnetic strip length may be in a range of 15-40 mm.

In additional aspects, to improve structural integrity of connection between the first connector 215 and the second connector 235, the first connector 215 and the second connector 235 may include additional magnetic elements. Specifically, the second connector distal portion 245 may include a third magnetic element (not shown) and the proximal part (or entire length) of the first connector distal portion 230 may include a fourth magnetic element (not shown) or metal. When the user inserts the first connector 215 into the second connector 235, the magnetic coupling between the third and fourth magnetic elements (or metal) may supplement the magnetic coupling between the first and second magnetic elements (or metal), and may add structural integrity to the connection between the first and second connectors 215, 235 (thus making eyeglasses 200 structure robust).

In some aspects, the third magnetic element may be a ferrous material and the fourth magnetic element may be a magnet. In other aspects, the third magnetic element may be a magnet and the fourth magnetic element may be a ferrous element.

Although FIG. 2 and the description above describes an aspect where the first connector 215 (and hence the second connector 235/cavity) is shaped as a cuboid, in additional aspects, the first connector 215 and the second connector 235 may have different shapes that may enhance user convenience of attaching/removing the first and the second connectors 215, 235 (and hence attaching/removing the arms 205 with the frame 210). Examples of different structural embodiments of first and second connectors 215, 235 are depicted in FIG. 3, and described in detail later in the description below.

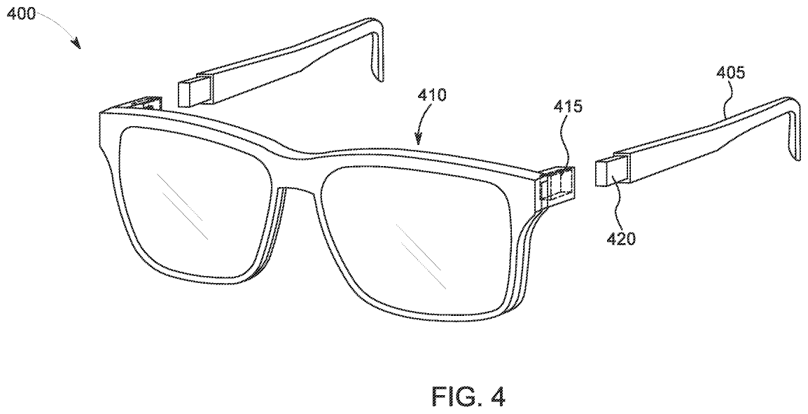

Further, although FIG. 2 and the description above describes an aspect where the second connector 235 includes the cavity, in an alternative aspect, the first connector 215 may include the cavity, as depicted in FIG. 4 and described in detail later in the description below.

FIG. 3 depicts example embodiments of an arm 302 and a first connector 304 of eyeglasses 300 in accordance with the present disclosure. Specifically, FIG. 3 depicts example embodiments of the eyeglasses 300 in which the first connector 304 may be inserted into a second connector 306 (shown in view 308). The first connector 304 may be connected with eyeglasses 300 side portion and the second connector 306 may be disposed inside the arm 302 (as described above). The eyeglasses 300 may be same as or similar to the eyeglasses 200, and may include same/similar components. Further, the first connector 304 and the second connector 306 may be similar to the first connector 215 and the second connector 235, respectively.

In some aspects, the first connector 304 may be made of similar material as the first connector 215; however, the first connector 304 may be structurally different from the first connector 215. Similarly, the second connector 306 may be made of similar material as the second connector 235 or the arm 205; however, the second connector 306 may be structurally different from the second connector 235. Different structures of first connector and second connector are shown in views 308 and 310 of FIG. 3.

In a first aspect, as shown in the view 308, the first connector 304 may include a first connector proximal portion 312, a first connector middle portion 314 and a first connector distal portion 316. In some aspects, the first connector distal portion 316 may be same as the proximal part of the first connector distal portion 230 (that may be disposed outside the frame side portion 220).

In an exemplary aspect, a first connector distal portion 316 length may be in a range of 15-25% of a combined length of the first connector proximal portion 312, the first connector middle portion 314 and the first connector distal portion 316.

The first connector middle portion 314 may be disposed between the first connector proximal portion 312 and the first connector distal portion 316. In an exemplary aspect, a first connector middle portion 314 length too may be in a range of 15-25% of the combined length of the first connector proximal portion 312, the first connector middle portion 314 and the first connector distal portion 316. Further, a first connector distal portion 316 width may be greater than a first connector proximal portion 312 width. In an exemplary aspect, the first connector proximal portion 312 width may be in a range of 40-60% of the first connector distal portion 316 width.

Further, as shown in the view 308, the first connector middle portion 314 may have a tapered width, which may gradually decrease from an intersection point associated with the first connector distal portion 316 and the first connector middle portion 314 to an intersection point associated with the first connector proximal portion 312 and the first connector middle portion 314.

In an exemplary aspect, a first connector proximal portion 312 length may be in a range of 50-70% of the combined length of the first connector proximal portion 312, the first connector middle portion 314 and the first connector distal portion 316.

The second connector 306 may have a shape complementary to first connector 304 shape, as shown in the view 308. Specifically, as shown in the view 308, the second connector 306 may include an elongated cavity having a cavity proximal portion 318, a cavity middle portion 320 and a cavity distal portion 322. The cavity proximal portion 318, the cavity middle portion 320 and the cavity distal portion 322 may have complementary shape to the first connector proximal portion 312, the first connector middle portion 314 and the first connector distal portion 316 respectively, and may be configured to engulf/enclose respective first connector portions when the user inserts the first connector 304 into the second connector 306.

The cavity middle portion 320 may be disposed between the cavity proximal portion 318 and the cavity distal portion 322. Further, the cavity middle portion 320 may have a tapered width that may gradually decrease from an intersection point associated with the cavity distal portion 322 and the cavity middle portion 320 to an intersection point associated with the cavity proximal portion 318 and the cavity middle portion 320. Stated another way, a cavity distal portion 322 width may be greater than a cavity proximal portion 318 width. Further, dimensions (e.g., length, width, etc.) associated with the cavity middle portion 320, the cavity proximal portion 318 and the cavity distal portion 322 may be same as or equivalent to dimensions associated with the first connector middle portion 314, the first connector proximal portion 312 and the first connector distal portion 316 respectively.

Example shapes of the first connector 304 and the second connector 306, as shown in the view 308, may enable the user to easily insert the first connector 304 into the second connector 306. Specifically, since the first connector proximal portion 312 width is substantially smaller than the cavity distal portion 322 width, the user may easily insert the first connector proximal portion 312 into the second connector 306 (i.e., inside the cavity proximal portion 318) via the cavity distal portion 322, without any obstruction.

In some aspects, the first connector proximal portion 312 may include a first magnetic element 324, which may be a magnet or a ferrous material. In other aspects, the first connector proximal portion 312 may be made of metal. The cavity proximal portion 318 may include a second magnetic element 326, which may be made of complementary ferrous material or a magnet. In some aspects, the first magnetic element 324/metal and the second magnetic element 326 may be disposed over entire lengths of respective first connector proximal portion 312 and cavity proximal portion 318. When the user inserts the first connector 304 into the second connector 306, the first magnetic element 324/metal may magnetically couple with the second magnetic element 326, thus enabling secure first and second connector attachment.

In additional aspects, the first connector middle portion 314 too may include the first magnetic element 324 or the metal, and the cavity middle portion 320 may include the second magnetic element 326. Presence of magnetic elements in the first connector middle portion 314 and the cavity middle portion 320 may further enhance magnetic attachment/coupling between the first connector 304 and the second connector 306. In yet another aspect, the first connector distal portion 316 and the cavity distal portion 322 too may include the first magnetic element 324 or the metal and the second magnetic element 326 respectively.

A different embodiment of the first connector 304 and the second connector 306 is shown as a first connector 328 and a second connector 330 in the view 310. In this case, the second connector 330 may not include a cavity that may completely “engulf” the first connector 328, as may be understood from the description below.

The first connector 328 and the second connector 330 may have tapered thickness, as well as tapered width. Tapered width associated with the first connector 328 and the second connector 330 may be same as the tapered width associated with the first connector 304 and the second connector 306, and hence not described again here for the sake of simplicity and conciseness.

In this case, as shown in the view 310, the second connector 330 may have a first portion 332 and a second portion 334. A first portion 332 thickness “T1” may be less than a second portion 334 thickness “T2”. Further, the second portion 330 may include a recess having a recess distal portion 336 and a recess proximal portion 338. In an exemplary aspect, a thickness of the recess distal portion 336 and the recess proximal portion 338 may be a difference between “T2” and “T1”. In some aspects, “T2” may be in a range of 0.25 to 0.75 centimeter, and “T1” may in a range of 0.1 to 0.4 centimeter.

In the aspect described above, the recess distal portion 336 and the recess proximal portion 338 may include the second magnetic element 326. Further, in this case, the first portion 332 may include a third magnetic element 340. The third magnetic element 340 may be disposed on an entire first portion 332 length, or may be disposed over a part of first portion 332 length (as shown in the view 310). Further, the third magnetic element 340 may be of any shape, e.g., rectangular, square, circular (as shown in the view 310), etc. The third magnetic element 340 may be a magnet or a ferrous material.

Further, in this case, the first connector 328 may have a shape (e.g., thickness and width) complementary to the shape of the first portion 332 and the second portion 334. The first connector 328 may include a fourth magnetic element 342 or a metal that may be disposed on a first connector 328 distal portion (as shown in the view 310), and may be complementary to the third magnetic element 340.

The fourth magnetic element 342/metal too may be disposed on an entire first connector 328 distal portion length, or may be disposed over a part of first connector 328 distal portion length (as shown in the view 310). Further, the fourth magnetic element 342/metal may be complementary in shape to the third magnetic element 340, and may be of any shape, e.g., rectangular, square, circular (as shown in the view 310), etc.

In the exemplary aspect depicted in the view 310, the recess distal portion 336 and the recess proximal portion 338 may not completely “engulf” corresponding first connector 328 portions. Instead, in this case, the first connector 328 and the second connector 330 may attach with each other “side-by-side” by using the varying thickness of the first portion 332 and the second portion 334.

When the user attaches the first connector 328 with the second connector 330, the fourth magnetic element 342 may magnetically attach/couple with the third magnetic element 340/metal, and provide secure attachment to the first connector 328 and the second connector 330. Presence of third and fourth magnetic elements 340, 342 may further strengthen first and second connector attachment (in addition to magnetic attachment associated with the first and second magnetic elements 324, 326).

FIG. 4 depicts example eyeglasses 400 with removable arms 405 in accordance with the present disclosure. The eyeglasses 400 may be same as or similar to the eyeglasses 200, and may include a frame 410 and a first connector 415. The frame 410 may be same as or similar to the frame 210, and hence is not described again here for the sake of simplicity and conciseness.

The first connector 415 may be structurally different from the first connector 215, for example, the first connector 415 may include a cavity (hereinafter referred to as cavity 415), as shown in FIG. 4. The cavity 415 may include one or more magnetic elements (or metal) such as a first magnetic element and a second magnetic element (similar to magnetic elements described above in conjunction with FIGS. 2 and 3).

The arm 405 may include a second connector 420 that may be structurally different from the second connector 235, for example, the second connector 420 may include a protrusion (i.e., an elongated shape, hereinafter referred to as protrusion 420). The protrusion 420 may have a shape complementary to cavity 415 shape, and may thus enable the user to easily insert the second connector 420 into the cavity 415. The cavity 415 may engulf/enclose the protrusion 420 when the user inserts the protrusion 420 into the cavity 415, thus enabling the user to removably attach the arm 405 with the frame 410.

The protrusion 420 may include one or more magnetic elements such as a third magnetic element and a fourth magnetic element (similar to magnetic elements described above in conjunction with FIGS. 2 and 3).

When the user inserts the protrusion 420 into the cavity 415, the magnetic coupling between the first and second magnetic elements with the third and fourth magnetic elements may enable secure arm and frame attachment.

Remaining eyeglasses 400 elements/components and their structural details are similar eyeglasses 200 elements/components, and are hence not described again here.

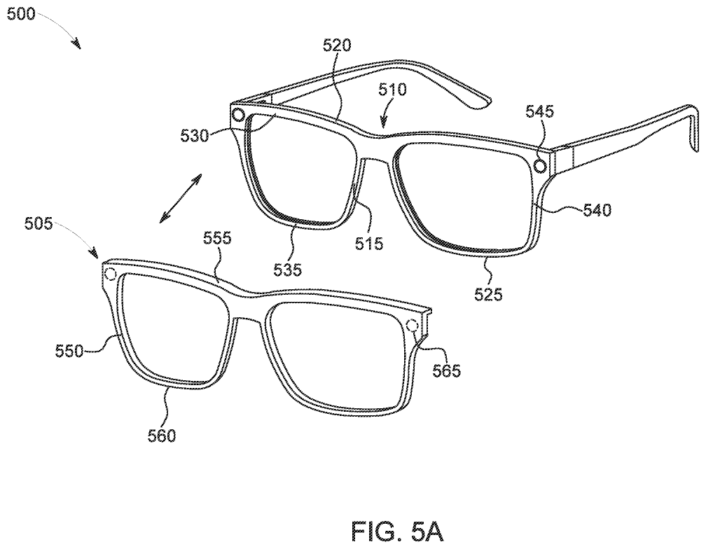

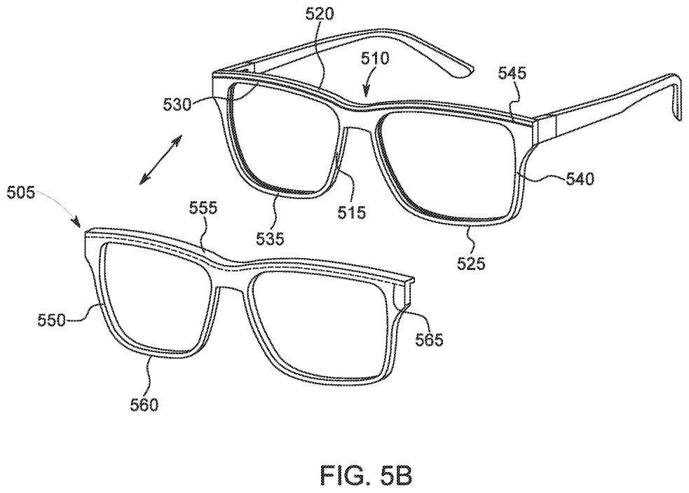

FIG. 5A depicts example eyeglasses 500 with removable fascia 505 in accordance with the present disclosure. The eyeglasses 500 may be similar to the eyeglasses 200/300, and may be configured to removably attach with interchangeable arms, as described in conjunction with FIGS. 2-4. For the same of simplicity, connection details of interchangeable arms are not depicted in FIG. 5A and subsequent figures, and are also not described again in the description below.

The eyeglasses 500 may include a frame 510 that may be same as the frame 110/210 (including “recess” to enable the user to insert lens 105 into the frame 510, as described in conjunction with FIG. 1). The frame 510 may include a frame front portion 515, a frame back portion (not shown) that may be opposite to the frame front portion 515, a frame top portion 520, and a frame bottom portion 525. Further, the frame front portion 515 may include a frame front top portion 530, a frame front bottom portion 535 and a frame front side portion 540.

In some aspects, the frame front portion 515 may include a first magnetic fastener 545. In the exemplary aspect shown in FIG. 5A, the first magnetic fastener 545 may be disposed at the frame front side portion 540. In another aspect, the first magnetic fastener 545 may be disposed at an intersection point associated with the frame front top portion 530 and the frame front side portion 540. In other aspects, the first magnetic fastener 545 may be disposed at any other location on the frame front portion 515.

The first magnetic fastener 545 may include a first magnetic element that may be a magnet or a ferrous material. The first magnetic fastener 545 may be of any shape, e.g., square, rectangular, oval, circular, etc., and may be of any dimension. In some aspects, first magnetic fastener 545 shape and/or dimension may be based on frame 510 shape and/or dimension.

As shown in FIG. 5A, the frame front portion 515 may include more than one magnetic fasteners. For example, the frame front portion 515 may include two magnetic fasteners, e.g., one on each (e.g., left and right) frame front side portions 540. In another aspect, the frame front portion 515 may include four magnetic fasteners (not shown), e.g., two on frame front side portions 540 and two on frame front bottom portions 535. In yet another aspect, two magnetic fasteners may be disposed on frame front top portions 530, and two magnetic fasteners on the frame front bottom portions 535.

The fascia 505 may be configured to removably attach with the frame front portion 515. The fascia 505 may have same or similar dimensions as frame 510 dimensions, so that the user may easily attach the fascia 505 with the frame front portion 515.

The fascia 505 may include a fascia front portion 550, a fascia back portion (not shown) that may be opposite to the fascia front portion 550, a fascia top portion 555, and a fascia bottom portion 560. The fascia back portion may include a second magnetic fastener 565 that may be similar (and complementary) to the first magnetic fastener 545. The second magnetic fastener 565 may include a second magnetic element that may be a ferrous material or a magnet. The second magnetic fastener 565 may be of any shape, e.g., square, rectangular, oval, circular, etc., and may be of any dimension. In some aspects, second magnetic fastener 565 shape and/or dimension may be based on fascia 505 shape and/or dimension, and/or first magnetic fastener 545 shape and/or dimension.

In other aspects, instead of having the second magnetic fastener 565, the fascia back portion may include one or more metallic elements.

The user may removably attach the fascia 505 with the frame 510 by placing the fascia back portion over the frame front portion 515. The fascia 505 may attach to the frame 510 by using magnetic coupling between the first magnetic fastener 545 and the second magnetic fastener 565 or the metallic elements.

The user may easily interchange the fascia 505 with another fascia of a different color or design by “pulling” the fascia 505 from the frame 510, and replacing the fascia 505 with the other fascia.

Although FIG. 5A depicts only magnetic attachment/coupling between the fascia 505 and the frame 510, in some aspects, the fascia 505 and the frame 510 may securely attach with each other via additional mechanical attachment means. An example of additional mechanical attachment means is depicted in FIG. 7 and described in detail later in the description below.

FIG. 5B depicts another embodiment of the eyeglasses 500 with the removable fascia 505 in accordance with the present disclosure. In the aspect depicted in FIG. 5B, the first magnetic fastener 545 and the second magnetic fastener 565/metallic element may be in a form of a magnetic and/or metallic strip. In this case, the first magnetic fastener 545 may be disposed on an entire frame front top portion 530 length or a portion of a frame front top portion 530 length. Similarly, the second magnetic fastener 565 or the metallic element (or a strip of metallic element) may be disposed on an entire length or a portion of a length of a top portion of the fascia back portion.

When the user places the fascia 505 on the frame front portion 515, the fascia 505 and the frame 510 may attach with each other via magnetic coupling between the magnetic strips associated with the first magnetic fastener 545 and the second magnetic fastener 565/metallic element.

In another aspect (not shown), a third magnetic fastener (that may be similar to the first magnetic fastener 545 or the second magnetic fastener 565) may additionally be disposed on the frame front bottom portion 535. Similarly, a fourth magnetic fastener (that may be similar to the first magnetic fastener 545 or the second magnetic fastener 565) or a metallic strip may additionally be disposed on a bottom portion of the fascia back portion. Attachment between the fascia 505 and the frame 510 may be made more robust and secure by magnetic coupling between the third magnetic fastener and the fourth magnetic fastener/metallic strip, when the user places the fascia 505 on the frame front portion 515.

Remaining eyeglasses 500 elements depicted in FIG. 5B are same as eyeglasses 500 elements depicted in FIG. 5A, and hence are not described again here for the sake of simplicity and conciseness.

FIG. 6 depicts an example connection mechanism between the frame 510 and the fascia 505 of the eyeglasses 500 of FIG. 5A, in accordance with the present disclosure. Specifically, FIG. 6 depicts a top view of the eyeglasses 500 of FIG. 5A. In an exemplary aspect, the first magnetic fastener 545 may be in a form of a cavity or a pocket (or may include a cavity or a pocket) that may be disposed on the frame front side portion 540 (or on any other portion, e.g., the frame front top portion 530 or the frame front bottom portion 535). As described above, the first magnetic fastener 545 may include a first magnetic element that may be a magnet or a ferrous material. In an exemplary aspect, the first magnetic element may be disposed on first magnetic fastener 545 interior back surface and first magnetic fastener 545 interior side surfaces. In another aspect, the first magnetic element may be disposed on one or more surfaces of first magnetic fastener 545 interior side or back surfaces.

The first magnetic fastener 545 may have any shape and/or dimension. For example, the first magnetic fastener 545 may be shaped as a cuboid, a cylinder, etc. Further, a first magnetic fastener 545 depth “D” may be based on a thickness of the frame 510, the frame top portion 520 and/or frame side portion. In an exemplary aspect, the depth “D” may be in a range of 40-70% of the thickness of the frame 510, the frame top portion 520 and/or frame side portion.

Further, the second magnetic fastener 565/metallic element may have a shape complementary to first magnetic fastener 545 shape. The second magnetic fastener 565/metallic element may be disposed on a fascia back side portion 605, at a location complementary to a first magnetic fastener 545 location on the frame 510. In an exemplary aspect, the second magnetic fastener 565/metallic element may be in a form of a protrusion that may be disposed on the fascia back side portion 605. A second magnetic fastener 565/metallic element thickness may be same as or equivalent to the first magnetic fastener 545 depth “D”.

The second magnetic fastener 565 may include a second magnetic element that may be a magnet or a ferrous material or a metallic element. In an exemplary aspect, the second magnetic element or the metallic element may be disposed on second magnetic fastener 565 exterior back surface and second magnetic fastener 565 exterior side surfaces. In another aspect, the second magnetic element or the metallic element may be disposed on one or more surfaces of second magnetic fastener 565 exterior side or back surfaces.

The user may “insert” the second magnetic fastener 565 into the first magnetic fastener 545 to attach the frame 510 with the fascia 505. Magnetic coupling between the second magnetic fastener 565/metallic element and the first magnetic fastener 545 may secure attachment between the frame 510 and the fascia 505.

In an alternative aspect (not shown), the first magnetic fastener 545 may be a protrusion that may be disposed on the frame front side portion 540 (or on any other location on the frame 510), and the second magnetic fastener 565 may be a cavity disposed on the fascia back side portion 605 (or on any other location on the fascia 505). In yet another aspect, a plurality of magnetic protrusions and cavities may be disposed at different positions on the frame front portion 515 and the fascia back portion, to further secure attachment between the frame 510 and the fascia 505.

FIG. 7 depicts another example connection mechanism between a fascia 705 and a frame 710 of eyeglasses 700 in accordance with the present disclosure. The eyeglasses 700 may be same as or similar to the eyeglasses 500. Further, the frame 710 may be same as or similar to the frame 510, and hence not described again here for the sake of simplicity and conciseness.

In some aspects, the frame 710 and the fascia 705 may include the first magnetic fastener 545 and the second magnetic fastener 565 respectively, as described in conjunction with FIGS. 5A and 5B. The magnetic fastener 545 and the second magnetic fastener 565 are not depicted in FIG. 7. In other aspects, the frame 710 and the fascia 705 may not include any magnetic fasteners/elements. In this case, the frame 710 and the fascia 705 may be removably attached with each other via mechanical attachment mechanism only, as described below. Further, in the preferred aspect depicted in FIG. 7, eyeglasses arms may not be interchangeable. Stated another way, the arms of the eyeglasses 700 may be attached to the frame 710 via hinge connectors (e.g., like conventional eyeglasses where the arms are attached to the frame/back plate) and may not be detachable.

The mechanical attachment mechanism between the frame 710 and the fascia 705 is described below, which does not require any magnetic attachment between the frame 710 and the fascia 705.

In the exemplary embodiment depicted in FIG. 7, the fascia 705 may include a first locking mechanism 715 and a second locking mechanism 720, as shown in view 725. The first locking mechanism 715 may be disposed on a fascia top portion 730, and the second locking mechanism may be disposed on a fascia bottom portion 735. The first locking mechanism 715 and a second locking mechanism 720 may be “clips” or “hooks” that may be disposed over an entire length or a portion of a length of fascia top and bottom portions respectively and may be configured to mechanically “lock” the fascia 705 with the frame 710. For example, the first and second locking mechanisms 715, 720 may be disposed only at a fascia top and bottom middle portions (not shown in FIG. 7). In another aspect (as shown in FIG. 7), the first and second locking mechanisms 715, 720 may be disposed may be disposed on entire fascia top and bottom lengths.

The user may flex the first and second locking mechanisms 715, 720 “backward” relative to a fascia plane “P”, and place the first and second locking mechanisms 715, 720 over respective frame top and bottom portions to make the fascia 705 “snap” onto the frame 710, thereby locking the fascia 705 with the frame 710. In this case, the fascia 705 may be made of flexible material, e.g., plastic, resin, and/or the like. Further, if the first and second locking mechanisms 715, 720 are disposed only at the fascia top and bottom middle portions, frame 710 top and bottom middle portions may include “recesses” or “sockets” (not shown) into which the first and second locking mechanisms 715, 720 may be hooked or locked. In additional aspects, the fascia 705 may include more than one first and second locking mechanisms 715, 720, and correspondingly the frame 710 may include more than one recesses or sockets.

The first locking mechanism 715 may include a first surface 740 and a second surface 745. The first surface 740 may be perpendicularly attached to the second surface 745, and may form an integrated unitary structure with the second surface 745. The first surface 740 may be disposed perpendicular to the fascia plane “P”, and the second surface 745 may be disposed parallel to the fascia plane “P”, as shown in FIG. 7.

When the user locks the fascia 705 with the frame 710, the first surface 740 and the second surface 745 may cover frame 710 top portion (not shown), thereby mechanically locking the fascia top portion 730 with the frame 710 top portion. Specifically, when the user locks the fascia 705 with the frame 710, the first surface 740 may cover the frame 710 top portion (e.g., the frame top portion 520) and the second surface 745 may cover frame 710 back top portion (not shown), thereby securely locking the fascia 705 with the frame 710.

In a similar manner, the second locking mechanism 720 may include a third surface 750 and a fourth surface 755. Second locking mechanism 720 structure may be similar to first locking mechanism 715 structure. For example, the third surface 750 may be perpendicularly attached to the fourth surface 755 and may form an integrated unitary structure with the fourth surface 755. The third surface 750 may be disposed perpendicular to the fascia plane “P”, and the fourth surface 755 may be disposed parallel to the fascia plane “P”, as shown in FIG. 7.

When the user locks the fascia 705 with the frame 710, the third surface 750 and the fourth surface 755 may cover frame 710 bottom portion (not shown), thereby mechanically locking the fascia bottom portion 735 with the frame 710 bottom portion.

In some aspects (not shown in FIG. 7), the fascia 705 may include only the first locking mechanism 715, and may not include the second locking mechanism 720.

Although the description above (e.g., related to FIGS. 1-4) describes aspects where the arms of the eyeglasses may be magnetically attached with the cover frame via frame side portions, in some aspects (as shown in FIG. 7), the arms may not be magnetically attached to the cover frame 710. In this case, the arms may be directly attached with the cover frame 710 via the frame hinges (and may not be removable), as described above. Further, in this case, to exchange the arms, the user may exchange the entire cover frame 710 with a new cover frame, and attach the new cover frame with the fascia 705. Similarly, to exchange the fascia 705, the user may remove existing fascia from the frame 710, and mechanically lock a new fascia over the frame 710.

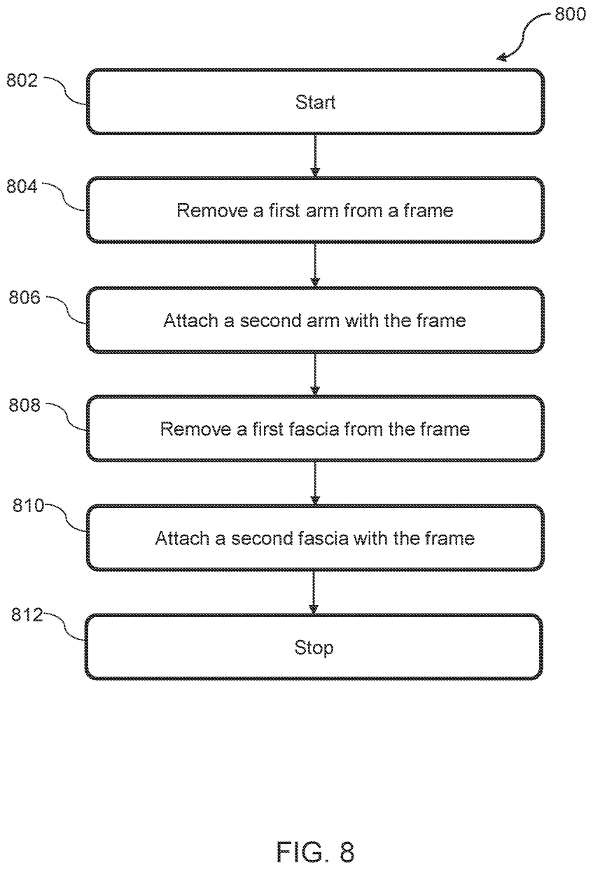

FIG. 8 depicts a flow diagram of an example method 800 to customize eyeglasses 100 in accordance with the present disclosure. FIG. 8 may be described with continued reference to prior figures, including FIGS. 1-7. The following process is exemplary and not confined to the steps described hereafter. Moreover, alternative embodiments may include more or less steps that are shown or described herein and may include these steps in a different order than the order described in the following example embodiments.

Referring to FIG. 8, at step 802, the method 800 may commence. At step 804, the method 800 may include removing a first arm from the frame 110. The first arm may be magnetically coupled with the frame 110, and the user may “pull” the first arm from the frame 110 to remove the first arm from the frame 110.

At step 806, the method 800 may include attaching a second arm with the frame 110. As described above, the second arm may attached with the frame 110 by using the first connector 304 and the second connector 306. In an exemplary aspect, the second arm may have a different color and/or design than first arm color and/or design.

At step 808, the method 800 may include removing a first fascia from the frame 110. As described above, the first fascia may be magnetically and/or mechanically coupled with the frame 110, and the user may “pull” the first fascia from the frame 110 to remove the first fascia from the frame 110.

At step 810, the method 800 may include attaching a second fascia with the frame 110. The second fascia may be magnetically and/or mechanically coupled with the frame 110, as described above.

At step 812, the method 800 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc., should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. Eyeglasses comprising:
a frame having a frame top portion, a frame bottom portion, and a frame side portion;
a first connector attached with the frame side portion, wherein:
the first connector comprises an elongated first connector proximal portion and a first connector distal portion,
the elongated first connector proximal portion comprises a first magnetic element, and the first connector distal portion comprises a second magnetic element; and
an arm having a second connector, wherein the second connector is configured to removably attach with the first connector, and wherein:
the second connector comprises a second connector proximal portion and a second connector distal portion,
the second connector proximal portion comprises a third magnetic element, and the second connector distal portion comprises a fourth magnetic element,
the first magnetic element is magnetically coupled with the third magnetic element, and the second magnetic element is magnetically coupled with the fourth magnetic element.

2. The eyeglasses of claim 1, wherein the first connector is attached with the frame side portion via the first connector distal portion.

3. The eyeglasses of claim 1, the first magnetic element comprises a magnet and the third magnetic element comprises a ferrous material.

4. The eyeglasses of claim 1, the first magnetic element comprises a metal and the third magnetic element comprises a magnet.

5. The eyeglasses of claim 1, the second magnetic element comprises a metal and the fourth magnetic element comprises a magnet.

6. The eyeglasses of claim 1, the second magnetic element comprises a magnet and the fourth magnetic element comprises a ferrous material.

7. The eyeglasses of claim 1, the second connector comprises an elongated cavity configured to enclose the elongated first connector proximal portion.

8. The eyeglasses of claim 1, wherein the second connector has an elongated shape, and wherein the first connector comprises a cavity configured to enclose the second connector.

9. Eyeglasses comprising:
a frame having a frame top portion, a frame bottom portion, and a frame side portion;
a first connector attached with the frame side portion, wherein:
the first connector comprises an elongated first connector proximal portion and a first connector distal portion,
the elongated first connector proximal portion comprises a first metal, and
the first connector distal portion comprises a second metal; and
an arm having a second connector, wherein the second connector is configured to removably attach with the first connector, and wherein:
the second connector comprises an elongated cavity having a cavity proximal portion and a cavity distal portion,
the elongated cavity is configured to enclose the elongated first connector proximal portion,
the cavity proximal portion comprises a first magnet,
the cavity distal portion comprises a second magnet,
the first magnet is magnetically coupled with the first metal, and
the second magnet is magnetically coupled with the second metal.

10. The eyeglasses of claim 9, wherein the first connector is attached with the frame side portion via the first connector distal portion.

11. Eyeglasses comprising:
a frame having a frame top portion, a frame bottom portion, and a frame side portion;
a first connector attached with the frame side portion, wherein:
the first connector comprises a first connector distal portion, a first connector proximal portion, and a first connector middle portion disposed between the first connector distal portion and the first connector proximal portion,
a first connector distal portion width is greater than a first connector proximal portion width, and the first connector middle portion has a tapered width,
the first connector proximal portion comprises a first magnetic element; and
an arm having a second connector, wherein the second connector is configured to removably attach with the first connector, and wherein:
the second connector comprises an elongated cavity having a cavity proximal portion, a cavity middle portion and a cavity distal portion,
the elongated cavity configured to enclose the first connector proximal portion,
the cavity proximal portion comprises a second magnetic element, and
the first magnetic element is magnetically coupled with the second magnetic element.

12. The eyeglasses of claim 11, wherein a cavity proximal portion width is less than a cavity distal portion width.

13. The eyeglasses of claim 11, wherein the cavity middle portion is disposed between the cavity proximal portion and the cavity distal portion.

14. The eyeglasses of claim 11, wherein the cavity middle portion has a tapered width.

15. The eyeglasses of claim 11, wherein the first magnetic element is a magnet and the second magnetic element is a ferrous material.

16. The eyeglasses of claim 11, wherein the first magnetic element is a metal and the second magnetic element is a magnet.

17. The eyeglasses of claim 11 further comprising:
a third magnetic element disposed at the first connector distal portion; and
a fourth magnetic element disposed at the cavity distal portion,
wherein the third magnetic element is magnetically coupled with the fourth magnetic element.

18. The eyeglasses of claim 17, wherein the third magnetic element is a magnet and the fourth magnetic element is a ferrous material.

19. The eyeglasses of claim 17, wherein the third magnetic element is a metal and the fourth magnetic element is a magnet.

20. The eyeglasses of claim 11, wherein the first connector is attached with the frame side portion via the first connector distal portion.
